(19) United States
(12) Patent Application Publication
(10) Pub. No.: US 2006/0248984 A1
(43) Pub. Date: Nov. 9, 2006

(54) Spinner assembly for oilfield tubular connections

(76) Inventor: Yaogen Ge, Katy, TX (US)

Correspondence Address: YAOGEN GE, 24215 Hamptonshire, Katy, TX, 77494, US

(21) Appl. No.: 11/120,720

(22) Filed: May 3, 2005

(51) Int. Cl. B25B 13/50; B25B 17/00

(52) U.S. Cl. 81/57.15; 81/57.33

(57) ABSTRACT

A tubular makeup and breakout assembly 10 includes a top spinner 20, an intermediate power tong 12 and a lower backup tong 14. The spinner comprises a frame 22 which houses a pair of hydraulic cylinders 24. A plurality of rollers 26 are each intended for frictional engagement with an outer surface of a tubular to rotate the tubular. Each roller 26 is powered by hydraulic drive motor 28. The roller receives a suitable drive shaft rotatably powered by the motor and having a polygonal cross-sectional configuration. The roller comprises segments which may be removed without removing the motor or the drive shaft.

### FIELD OF THE INVENTION

The present invention relates to equipment and techniques for threading and unthreading oilfield tubular members, such as drill pipe, which are run into and out of a well. More particularly, the invention relates to a spinner of a type used with a power tong and a backup tong supported on the floor of an oilfield rig.

### BACKGROUND OF THE INVENTION

Various types of equipment has been devised for making up and breaking apart oilfield tubular members at a well site. U.S. Pat. No. 4,005,621 discloses a power tong for rotating tubular members. The power tong includes three circumferentially spaced jaws. A closed power tong with a plurality of jaws as disclosed in U.S. Pat. No. 5,000,065.

In other applications, a spinner tool having a plurality of rollers is used for engaging a tubular member to rotate the tubular member, with high torque for final making up and breaking apart the threaded connection being provided by other equipment. U.S. Pat. No. 4,446,761 discloses a spinner assembly for rotating oilfield tubular goods. U.S. Pat. No. 3,799,009 discloses an assembly comprising a spinner, a tong for making up or breaking apart the connection, and a backup tong for securing the lower pipe in position. U.S. Pat. No. 5,054,500 discloses a spinner assembly with toothed belts for driving rollers.

U.S. Pat. No. 5,791,206 discloses a breakout wrench for making and breaking joints between successive lengths of drill pipe. More particularly, circumferentially spaced dies engage the drill pipe.

One type of assembly including an upper spinner, an intermediate power tong for making up and breaking apart the threaded connection, and a lower tong is referred to as an “iron roughneck.” U.S. Pat. No. 6,206,096 discloses an iron roughneck assembly, and more particularly a spinner with a plurality of rollers for rotating an upper tubular member. U.S. Pat. No. 6,253,845 discloses various embodiments for a roller of a spinner assembly.

The problems with the prior art equipment involved in threading and unthreading oilfield tubular members involve the high cost of manufacturing equipment, the complicated nature of the equipment which requires high maintenance, and the time and expense associated with replacing worn rollers in the spinner assembly.

The disadvantages of the prior art are overcome by the present invention, and an improved spinner assembly is hereinafter disclosed for threading and unthreading oilfield tubular connections.

### SUMMARY OF THE INVENTION

In one embodiment, a spinner assembly is provided for threading and unthreading substantially vertical oilfield tubular goods at the location above a floor at a well site. The spinner assembly includes a spinner frame, a plurality of rotatable rollers each supported on the frame and having a substantially vertical axis, and a plurality of motors each for powering a respective roller. An actuator moves one or more rollers with respect to the frame to move the one or more rollers into and out of engagement with an oilfield tubular member. Each roller may have a central passageway therein having at least a portion with a polygonal configuration for mating with a drive member rotatable by a respective motor. Each roller may have two or more axially spaced cylindrical portions, with a lower end of an upper cylindrical portion engaging an upper end of a lower cylindrical portion. Each cylindrical portion may have first and second arcuate members each having a generally semi-cylindrical exterior surface and end surfaces spaced adjacent ends of a respective exterior surface. The end surfaces of the arcuate members are in planar engagement, and the end surfaces of the upper cylindrical portion are circumferentially offset from the end surfaces of a lower cylindrical portion. A plurality of securing members each extend axially between the two or more axially spaced portions, and interconnect the two or more cylindrical portions.

In another embodiment, the spinner assembly includes a pair of opposing actuators each for moving a pair of rollers into and out of engagement with an oilfield tubular member. A mounting bracket is provided for supporting a pair of rollers and a corresponding pair of motors. The mounting bracket is pivotal with respect to a respective actuator, thereby obtaining contact between each of the pair of rollers and the tubular members.

In another embodiment, a roller is provided for a spinner assembly to thread and unthread oilfield tubular goods at a well site. The roller includes two or more axially spaced cylindrical portions, with a lower end of an upper cylindrical portion engaging an upper end of a lower cylindrical portion. Each cylindrical portion has first and second arcuate members each having a generally semi-cylindrical exterior surface and end surfaces spaced adjacent ends of a respective exterior surface. The end surfaces of the first and second arcuate members are substantially in planar engagement, and the end surfaces of the upper cylindrical portion are circumferentially offset from the end surfaces of the lower cylindrical portion. A plurality of securing members each extend axially between the two or more axially spaced portions and interconnect the cylindrical portions.

These and further features and advantages of the present invention will become apparent from the following detailed description, wherein reference is made to the figures in the accompanying drawings.

### BRIEF DESCRIPTION OF THE DRAWINGS

FIG. 1 is a simplistic side view of equipment according to the present invention for making up and breaking apart oilfield tubular connections.

FIG. 2 is an exploded view of the spinner generally shown in FIG. 1.

FIG. 3 is a top view of the spinner shown in FIG. 1.

FIG. 4 is a side view of the spinner shown in FIG. 1.

FIG. 5 is a pictorial view of a bracket supporting a pair of rollers and a pair of motors.

FIG. 6 is a pictorial view of the bracket generally shown in FIG. 5.

FIG. 7 is a pictorial view of a drive member rotatable by a motor for rotating a respective roller.

FIG. 8 is a pictorial view of a disassembled roller.

FIG. 9 is a pictorial view of the assembled roller.

FIG. 10 is pictorial view of another embodiment of a partially disassembled roller.

FIG. 11 is a pictorial view of the assembled roller.

FIG. 12 is a pictorial view of yet another embodiment of a partially disassembled roller.

FIG. 13 is a pictorial view of the assembled roller.

### DESCRIPTION OF THE PREFERRED EMBODIMENTS

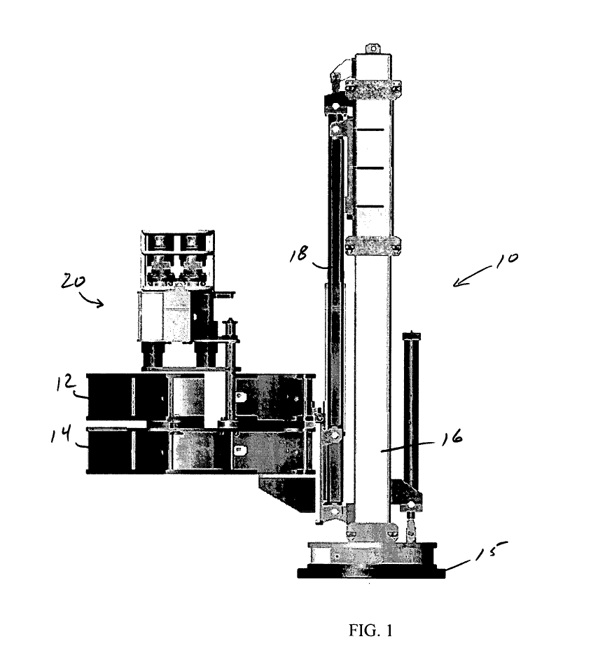

FIG. 1 illustrates a tubular makeup and breakout assembly 10 for positioning on a rig floor at a well site. Those skilled in the art will appreciate that a substantially vertical oilfield tubular string comprising threaded joints or members may be received within a top spinner 20, an intermediate power tong 12 for final makeup and breakout of the threads, and a lower backup tong 14. Base 15, vertical post 16, and linkage arms 18 support the spinner and tongs, and allow both lateral and axial (vertical) movement with respect to the rig floor.

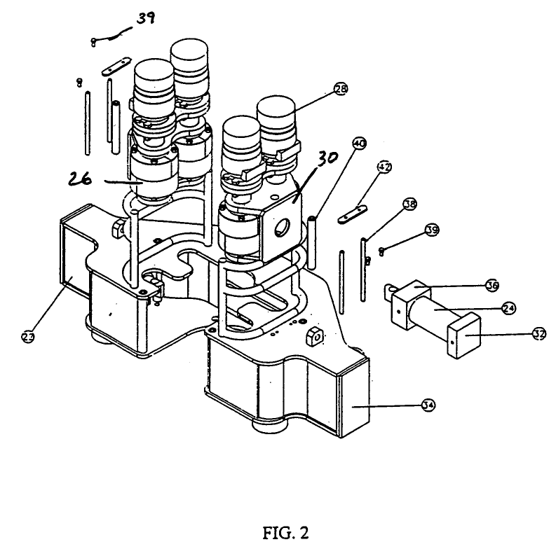

Referring now to FIG. 2, the spinner 20 generally shown in FIG. 1 is illustrated in greater detail. The spinner comprises a frame 22 which substantially houses a pair of hydraulic cylinders 24, with each hydraulic cylinder axis being substantially aligned and passing through a central axis of the tubular. FIG. 2 also illustrates a plurality of rollers 26 each intended for frictional engagement with an outer surface of the tubular to rotate or spin the tubular. Each roller 26 is powered by a hydraulic drive motor 28, which as shown in FIG. 2 is positioned above the roller and is supported on a bracket 30.

Rearward surface 32 of each cylinder 24 engages an end plate 34 of the housing 22. A radially inward cylinder block 36 retains the cylinder at a fixed location within the housing 22 by engagement with a pair of pins 38, which may be easily removed through a top or bottom surface of the housing 22 to replace the cylinder, if necessary. Plate 42 may be provided on the exterior surface of frame 22 to cover the pins 38, and also has holes to receive fasteners 39. A pin 40 interconnects the cylinder rod 25 with the bracket 30 (see FIG. 4), such that the bracket may rotate relative to the axis of the cylinder.

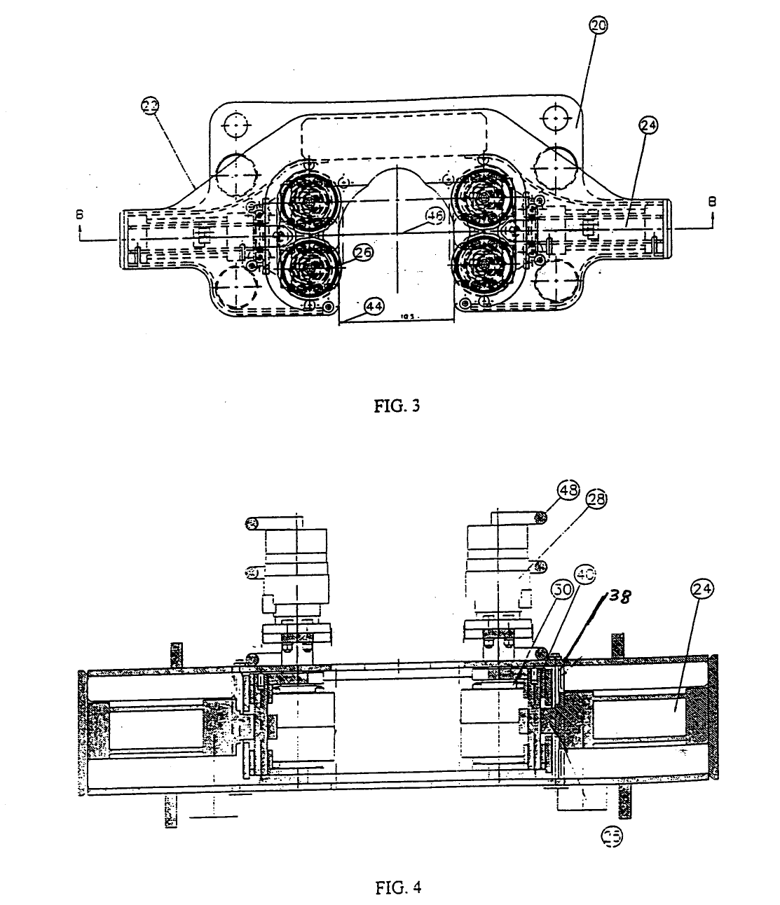

FIG. 3 is a top view of a spinner 20 shown in FIG. 2, illustrating the open throat 44 in the frame 22 for receiving a tubular member therein. Actuation of the cylinders 24 move the rollers 26 inward along common axis 46 to engage the tubular. FIG. 4 illustrates the frame 48 for protecting the motors 28, and further illustrates the pivotal connection of the frame 30 provided by the pin 40 at the rod end of each cylinder 24.

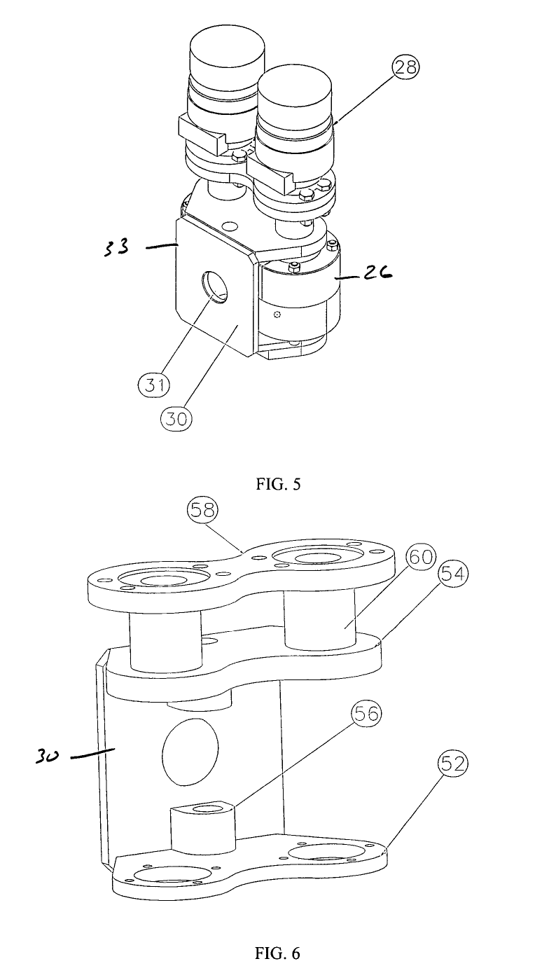

FIG. 5 illustrates in greater detail two motors 28, each for powering a respective roller 26, and the bracket 30 for supporting both the rollers and the motors. Bracket 30 includes a hole 31 in the radially outward plate 33 for receiving the rod end of a cylinder, and allows pivoting movement of the bracket 30 with respect to the axis of the cylinder 24. FIG. 6 illustrates in greater detail suitable configuration for the bracket 30, with a lower plate 52 having a pair of apertures each for receiving a respective roller bearing assembly, and a similar cavity in the plate 54 housing an upper bearing assembly. A pair of end caps 56 are provided for rotatably supporting the rod 40, which may be slid into position through a suitable hole in plate 54. Upper plate 58 is supported on a pair of hollow posts 60, which house the drive shafts interconnecting each motor with a respective roller.

FIG. 7 shows a suitable drive shaft 62 having a splined end 64 for coupling to the output shaft of the motor, and an elongate substantially rectangular block 66. As explained subsequently, it is a feature of the invention that the roller have a center passageway with at least a portion having polygonal cross-sectional configuration for receiving an elongate polygonal portion of a drive shaft from the motor. Although a shaft with a square cross-section is depicted, the shaft and the mating passageway in the roller could have a hexagonal or octagonal cross-sectional configuration. In a preferred embodiment, the polygonal configuration of the drive shaft extends at least substantially through the length of the passageway through the roller.

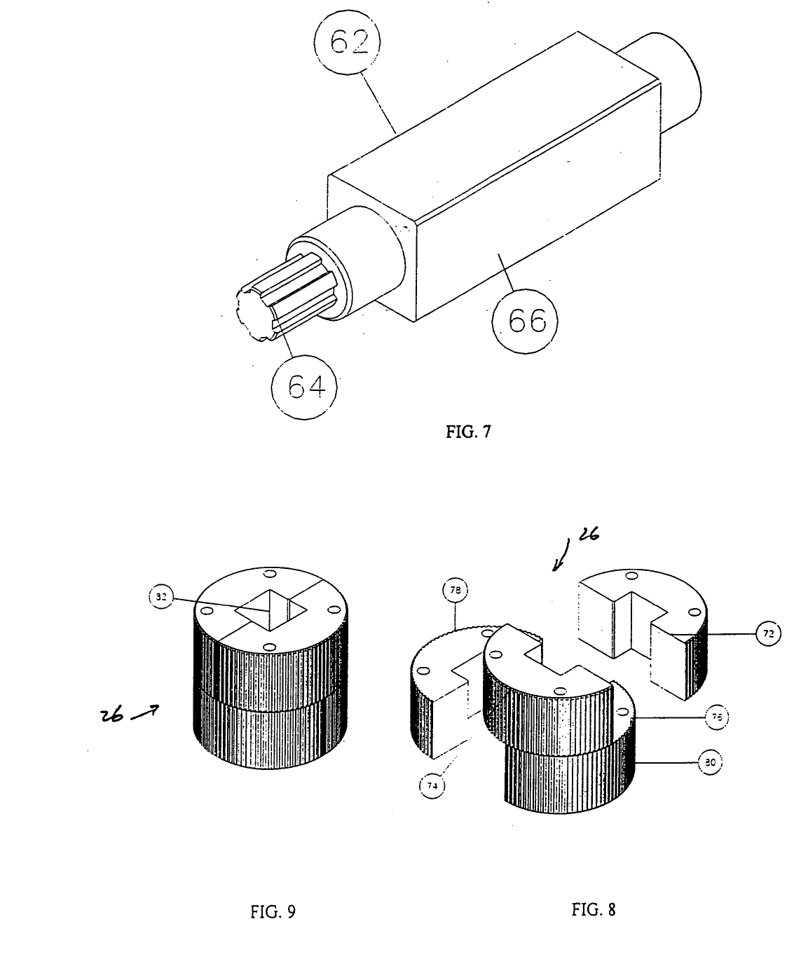

FIG. 8 illustrates a roller 26 composed of segments 72, 74 which together form an upper half of the roller, and segments 76 and 78 which together form a lower half of the roller. In a preferred embodiment, each of the segments 72, 74, 76 and 78 is identical in structure, thereby significantly reducing manufacturing costs. Each segment has an outer surface 80 which may be grooved or otherwise profiled for increasing frictional engagement with a tubular. FIG. 9 illustrates a roller 26 having a rectangular passageway 82 extending therethrough for receiving the rectangular block 66 of the drive shaft 62. As shown in FIG. 9, the planar end faces of the arcuate portions engage, and the end surfaces of the lower segments are rotated 90 degrees with respect to the end surfaces of the upper segment. This allows suitable bolts to be passed through the underside of a lower segment and through an aligned bolt hole in the upper segment, and a nut placed on top of the bolt, such that four bolts hold the assembly together, as shown in FIG. 5. During disassembly, the bolts can be removed and one or all of the arcuate segments taken off the drive shaft 62 without removing the motor or the drive shaft.

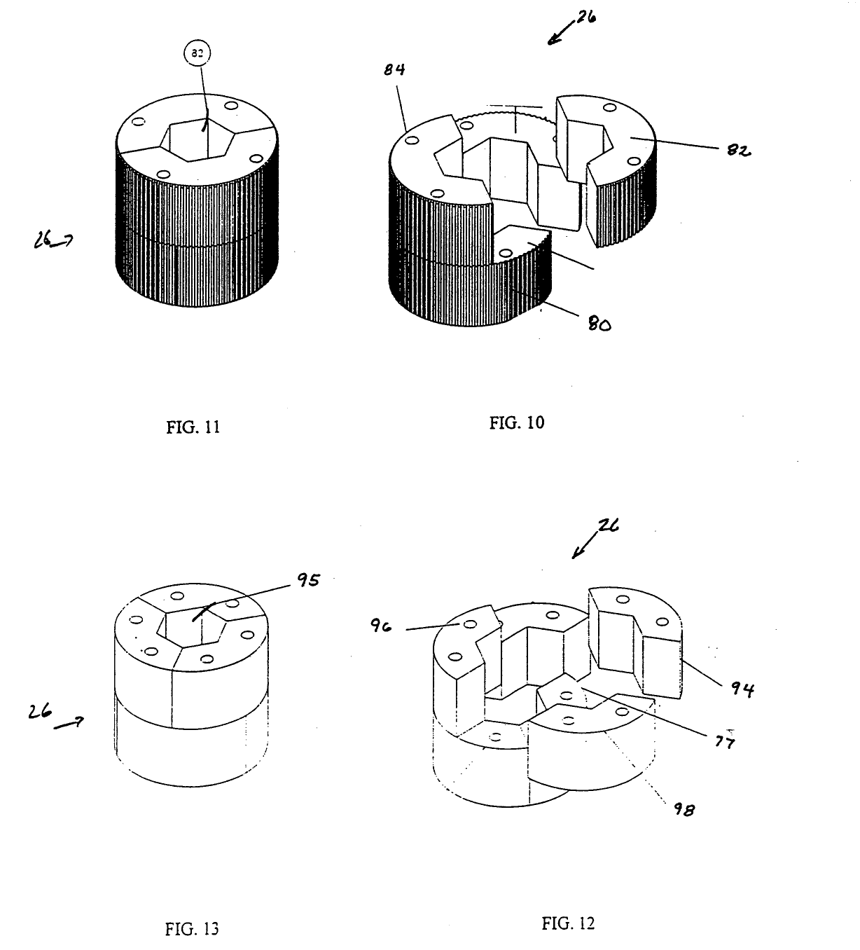

FIG. 10 illustrates another embodiment of a roller 26 composed of segments 82 and 84 which together form an upper or a lower half of the roller. Each segment again is preferable identical in structure, and has an outer surface which may be profiled for increasing frictional engagement with the tubular. The FIG. 10 embodiment differs from the FIG. 8 embodiment in that the passageway 82 extending through the roller has substantially a hexagonal cross-sectional configuration. The assembled roller is shown in FIG. 11, and four bolts may be used to hold the roller assembly together.

FIG. 12 illustrates yet another embodiment of a roller 26 wherein each upper and lower layer is comprised of three segments 94, 96 and 98 which together form the upper or lower half of the roller. As with the other embodiments, the segments are identical in structure and have an outer surface for frictional engagement with a tubular. As shown in FIG. 13, a hexagonal shaped passageway 95 is provided through the roller, and six bolts passing through an underside of the lower segment and through an aligned bolt hole in the upper segment may be used in conjunction with six nuts to hold the assembly together. For this embodiment, the offset angle between planar surfaces would be approximately 60 degrees.

Those skilled in the art will appreciate that each roller may be formed from two or more axially stacked cylindrical portions, with each cylinder portion formed from a pair of arcuate members with end surfaces positioned along a plane that passes substantially through the axis of the roller. A thin pad could be provided between these cylindrical portions to prevent their engagement, with a lower end of the upper cylindrical portion then spaced slightly above the upper end of a lower cylindrical portion.

The pair of arcuate members which form each cylindrical portion preferably have end surfaces in planar engagement, although the end surfaces could be spaced slightly from each other. The end surfaces of the cylindrical portions are circumferentially offset for an assembled roller, such that a plurality of bolts or other securing members may extend between and interconnect the axially spaced cylindrical portions. Each bolt or securing member may be removed from a respective roller through the bottom of the roller, such that the securing member is removed in a direction opposite the motor with respect to the roller.

The embodiment disclosed herein utilizes four rollers and a motor for powering each roller. In other embodiments, additional rollers may be provided, with at least two rollers being powered for rotating the tubular, and at least two other rollers for engaging and stabilizing the rotating tubular. In other embodiments, a motor to be provided at each end of the drive shaft, so that two motors powered a single roller. Other combinations may include some rollers powered by two motors, and other motors powered by a single roller.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A spinner assembly for threading or unthreading substantial vertical oilfield tubular goods above a floor at a well site, comprising:
a spinner frame;
a plurality of rotatable rollers each supported on the frame and having a substantially vertical axis;
a plurality of motors each for powering a respective roller;
an actuator for moving one or more rollers with respect to the frame to move the one or more rollers into and out of engagement with an oilfield tubular member;
each roller having a central passageway therein, each passageway having a portion with a polygonal configuration for mating with a drive member rotatable by a respective motor;
each roller having two or more axially spaced cylindrical portions, a lower end of an upper cylindrical portion spaced above an upper end of a lower cylindrical portion;
each cylindrical portion having first and second arcuate members each having a generally semi-cylindrical exterior surface and end surfaces spaced adjacent ends of a respective exterior surface, the end surfaces of the first and second arcuate members being in planar engagement, and the end surfaces of the upper cylindrical portion being circumferentially offset from the end surfaces of the lower cylindrical portion; and
a plurality of securing members each extending between and interconnecting the two or more axially spaced cylindrical portions.

2. A spinner as defined in claim 1, wherein the plurality of rollers comprise four circumferentially spaced rollers each in engagement with the tubular member when rotating the tubular member.

3. A spinner as defined in claim 1, wherein the actuator moves a pair of rollers into and out of engagement with the tubular member, and another actuator moves another pair of rollers into and out of engagement with the tubular member.

4. A spinner as defined in claim 1, wherein the polygonal configuration of the central passageway is one of a rectangular shape, hexagonal shape, or an octagonal shape in cross section.

5. A spinner assembly as defined in claim 1, wherein the plurality of securing members includes at least four securing members, and the end surfaces of the upper cylindrical portion are offset from the end surfaces of a lower cylindrical portion.

6. A spinner as defined in claim 1, further comprising:
a mounting bracket for supporting a pair of rollers and a corresponding pair of motors, the mounting bracket being movable by the actuator with respect to the spinner frame.

7. A spinner assembly as defined in claim 6, wherein the mounting bracket is pivotal with respect to the actuator.

8. A spinner assembly as defined in claim 1, wherein the spinner frame has an open throat for laterally receiving the oilfield tubular member herein.

9. A spinner assembly as defined in claim 1, wherein each of the plurality of securing members is removable from a respective roller in a direction opposite the motor with respect to a respective roller.

10. A spinner assembly for threading or unthreading substantial vertical oilfield tubular goods above a floor at a well site, comprising:
a spinner frame;
a plurality of rotatable rollers each supported on the frame and having a substantially vertical axis;
a plurality of motors each for powering a respective roller;
a pair of opposing actuators each for moving a pair of rollers into and out of engagement with an oilfield tubular member;
a mounting bracket for supporting a pair of rollers and a corresponding pair of motors, the mounting bracket being movable by the actuator with respect to the spinner frame; and
the mounting bracket is pivotal with respect to a respective actuator.

11. A spinner assembly as defined in claim 10, wherein the central axis of the pair of actuators are substantially coaxial.

12. A spinner assembly as defined in claim 10, wherein each actuator comprises a hydraulic cylinder.

13. A spinner assembly as defined in claim 10, further comprising:
each roller having a central passageway therein, each passageway having a portion with a polygonal configuration for mating with a drive member rotatable by a respective motor.

14. A spinner assembly as defined in claim 10, wherein the spinner frame has an open throat for laterally receiving an oilfield tubular member herein.

15. A spinner assembly as defined in claim 10, further comprising:
each roller having two or more axially spaced cylindrical portions, a lower end of an upper cylindrical portion engaging an upper end of a lower cylindrical portion; and
each cylindrical portion having first and second arcuate members each having a generally semi-cylindrical exterior surface and end surfaces spaced adjacent ends of a respective exterior surface, the end surfaces of the first and second arcuate members being in planar engagement, and the end surfaces of the upper cylindrical portion being circumferentially offset from the end surfaces of the lower cylindrical portion.

16. A roller for a spinner assembly to thread and unthread oilfield tubular goods at a well site, the roller comprising:
two or more axially spaced cylindrical portions, a lower end of an upper cylindrical portion engaging an upper end of a lower cylindrical portion;
each cylindrical portion having first and second arcuate members each having a generally semi-cylindrical exterior surface and end surfaces spaced adjacent ends of a respective exterior surface, the end surfaces of the first and second arcuate members being in planar engagement, and the end surfaces of the upper cylindrical portion being circumferentially offset from the end surfaces of the lower cylindrical portion; and
a plurality of securing members each extending axially between the two or more axially spaced portions and interconnect the two or more cylindrical portions.

17. A roller as defined in claim 16, further comprising:
the roller having a central passageway therein, the passageway having a portion with a polygonal configuration for mating with a drive member rotatable by a respective motor.

18. A roller as defined in claim 17, wherein the polygonal configuration of the central passageway is one of a rectangular shape, hexagonal shape, or an octagonal shape in cross section.

19. A roller as defined in claim 16, wherein the plurality of securing members includes at least four securing members, and the end surfaces of the upper cylindrical portion are offset from the end surfaces of a lower cylindrical portion.

20. A roller as defined in claim 16, wherein each of the plurality of securing members is removable from a respective roller in a direction opposite a roller motor with respect to the roller.
